(19) United States
(12) Patent Application Publication
(10) Pub. No.: US 2012/0320086 A1
(43) Pub. Date: Dec. 20, 2012

(54) INFORMATION PROCESSING DEVICE AND INFORMATION PROCESSING METHOD

(75) Inventors: Kouichirou KASAMA, Kawasaki (JP); Junko TOGAWA, Kawasaki (JP); Toshihiro AZAMI, Yokosuka (JP)

(73) Assignee: FUJITSU LIMITED, Kawasaki-shi (JP)

(21) Appl. No.: 13/477,193

(22) Filed: May 22, 2012

(30) Foreign Application Priority Data
Jun. 16, 2011 (JP) 2011-134376

(51) Int. Cl. G09G 5/00

(52) U.S. Cl. 345/629

(57) ABSTRACT

An information processing device that overlaps and displays a visible-light image and a thermal image, comprising: a visible-light image acquiring unit that acquires a visible-light image of an object; a thermal image acquiring unit that acquires a thermal image specifying a temperature distribution of the object; and a display controller that uses the acquired visible-light image and the acquired thermal image and specifies a thermal image of a certain part whose temperature is different from another part surrounding the certain part of the object and controls to display the thermal image of the certain part to be displayed in a display state that is different from other parts of the object.

### CROSS-REFERENCE TO RELATED APPLICATION(S)

This application is based upon and claims the benefit of priority of the prior Japanese Patent Application No. 2011-134376, filed on Jun. 16, 2011, the entire contents of which are incorporated herein by reference.

### FIELD

The embodiment discussed herein is related to an information processing device and an information processing method.

### BACKGROUND

With the development of image processing techniques, there are conventional mobile terminals that are used as small display devices and each capable of imaging an object with visible light and displaying a visible-light image of the object. Among the mobile terminals, there is a mobile terminal that displays not only a visible-light image but also a thermal image (thermography) that enables a temperature distribution of an object to be easily identified on a screen. The visible-light image is an image formed by imaging visible light reflected by the object. A user of the mobile terminal can visually identify details of the object with naked eyes, depending on the resolution of the visible-light image. Since the thermal image is displayed so that differences between the temperatures of parts of a surface of the object are identified using colors, the user can identify an outline of the object from the thermal image. It is, however, difficult for the user to visually identify details of the object from the thermal image. In recent years, making use of the characteristics of the images, overlapping and displaying the visible-light image and the thermal image on the same screen has been proposed.

According to the aforementioned technique, the user can simultaneously view the two images. However, the visible-light image and the thermal image, which are formed by imaging the same object, are overlapped with each other. Thus, the technique has a problem that one of the images is hidden by the other image and it is difficult to view the images. Especially, when differences between the temperatures of parts of the object are large, it is considered that the user wants to know in detail a temperature distribution of a specific part of the object whose temperature is different from another part of the object surrounding the specific part. In this case, when one of the images is superimposed on the other image, a visible-light image of the specific part is hidden by a color of the thermal image. This effect inhibits the temperature distribution from being accurately identified. As a result, it is difficult for the user to accurately identify the temperatures of parts of the object on the screen.

### SUMMARY

According to an aspect of the invention, a device includes, an information processing device that overlaps and displays a visible-light image and a thermal image, comprising: a visible-light image acquiring unit that acquires a visible-light image of an object; a thermal image acquiring unit that acquires a thermal image specifying a temperature distribution of the object; and a display controller that uses the acquired visible-light image and the acquired thermal image and specifies a thermal image of a certain part whose temperature is different from another part surrounding the certain part of the object and controls to display the thermal image of the certain part to be displayed in a display state that is different from other parts of the object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a functional configuration of an information processing device.

FIG. 2 is a diagram illustrating a hardware configuration of the information processing device.

FIG. 3 is a flowchart of operations of the information processing device.

FIG. 4 is a diagram illustrating an example of matrix information in which a thermal image and a visible-light image are associated with each other.

FIG. 5 is a flowchart of a process of specifying an outline on the visible-light image.

FIG. 6 is a flowchart of a process of changing a display state of a specific region of the thermal image.

### DESCRIPTION OF EMBODIMENT

Hereinafter, an embodiment of an information processing device disclosed herein and an information processing method disclosed herein is described in detail with reference to the accompanying drawings.

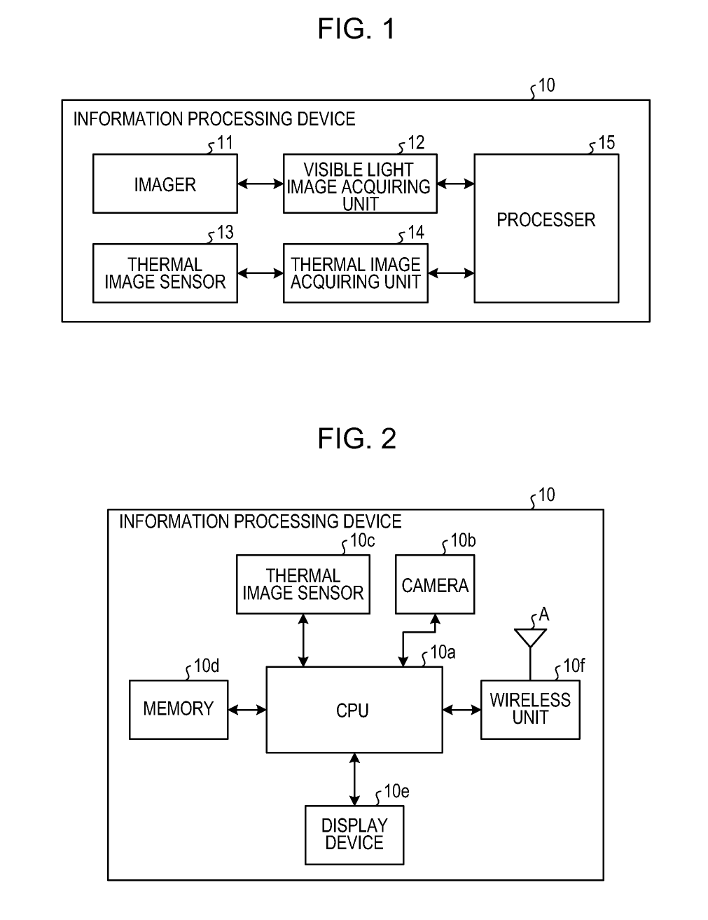

First, the configuration of an information processing device 10 according to the embodiment is described below. FIG. 1 is a diagram illustrating a functional configuration of the information processing device 10 according to the embodiment. As illustrated in FIG. 1, the information processing device 10 includes an imager 11, a visible-light image acquiring unit 12, a thermal image sensor 13, a thermal image acquiring unit 14 and a processor 15. The imager 11, the visible-light image acquiring unit 12, the thermal image sensor 13, the thermal image acquiring unit 14 and the processor 15 are connected to each other so that a signal and data can be unidirectionally or bidirectionally input to and output from the imager 11, the visible-light image acquiring unit 12, the thermal image sensor 13, the thermal image acquiring unit 14 and the processor 15.

The imager 11 includes a solid-state imaging element and an image processor. The image processor converts an image of an object imaged by the solid-state imaging element into digital image data. The imager 11 outputs the digital image data as a visible light image to the visible-light image acquiring unit 12.

The visible-light image acquiring unit 12 sets information on an imaging method to be used by the imager 11 on the basis of an imaging mode indicated by information transmitted by the processor 15 (described later). The information to be set includes the size of an image to be acquired, a focal position and a flame rate. The visible-light image acquiring unit 12 acquires the visible-light image from the imager 11 and outputs the visible-light image to the processor 15.

The thermal image sensor 13 is a noncontact sensor that has 64 or more thermopiles arranged in an array. The thermal image sensor 13 measures temperatures of parts of a surface of the object on the basis of infrared rays emitted by the object imaged by the imager 11. The thermal image sensor 13 outputs, to the thermal image acquiring unit 14, image data that serves as a thermal image and indicates a temperature distribution from which differences between the measured temperatures are identified using colors. The thermal image sensor 13 may be an infrared array sensor. The infrared array sensor receives the infrared rays emitted by the object imaged by the imager 11, uses a pyroelectric effect and senses the temperatures of the parts of the surface of the object.

The thermal image acquiring unit 14 holds and manages, for each of pixels, temperature information that is periodically received from the thermal image sensor 13. For example, the thermal image acquiring unit 14 acquires the thermal image from the thermal image sensor 13 when the visible-light image acquiring unit 12 acquires the visible-light image from the imager 11. The thermal image acquiring unit 14 outputs the acquired thermal image to the processor 15. The thermal image acquiring unit 14 may acquire the thermal image from the thermal image sensor 13 regardless of the operation of the visible-light image acquiring unit 12.

The processor 15 uses the visible-light image acquired by the visible-light image acquiring unit 12 and the thermal image acquired by the thermal image acquiring unit 14 and thereby specifies, on the basis of matrix information 151 (described later), a part of the object whose temperature is different from another part of the object surrounding the specified part. The processor 15 causes a display device 10e to display a thermal image of the specified part so that a display state of the thermal image of the specified part is different from other parts of the object. Specifically, the processor 15 causes the display device 10e to display the thermal image with a larger number of pixels than pixels used for the other parts or to display the thermal image with a transmittance that is higher than a transmittance for the other parts. For example, the processor 15 performs a process of specifying, on the basis of the luminance of a visible-light image of a certain region whose temperature is different from another region surrounding the certain region on the thermal image, an outline that defines a boundary between the certain region and the other region. In addition, the processor 15 performs a process of changing a display state of a thermal image (corresponding to the visible-light image within the outline specified in the process) to a high-resolution state or a high-transmittance state. Before the display state is changed, the number of pixels of the thermal image is smaller than the number of pixels of the visible-light image. The processor 15 performs the process (described later) of changing the display state and thereby increases the number of the pixels of the thermal image, compared with the number of the pixels before the change in the display state, so that the number of the pixels of the thermal image is equal to or larger than the number of the pixels of the visible-light image.

The information processing device 10 is physically achieved by, for example, a mobile phone. FIG. 2 is a diagram illustrating a hardware configuration of the information processing device 10 that is physically achieved by, for example, the mobile phone. As illustrated in FIG. 2, the information processing device 10 physically includes a central processing unit (CPU) 10a, a camera 10b, a thermal image sensor 10c, a memory 10d, a display device 10e and a wireless unit 10f that has an antenna A. The imager 11 is achieved by the camera 10b as described above. The visible-light image acquiring unit 12, the thermal image acquiring unit 14 and the processor 15 are achieved by an integrated circuit that is, for example, the CPU 10a. The data of the visible-light image and the data of the thermal image are held by the memory 10d that is a random access memory (RAM), a read only memory (ROM), a flash memory or the like. The display device 10e that is, for example, a liquid crystal display device displays the visible-light image and the thermal image so that one of the images is superimposed on the other image.

Next, operations of the information processing device 10 are described.

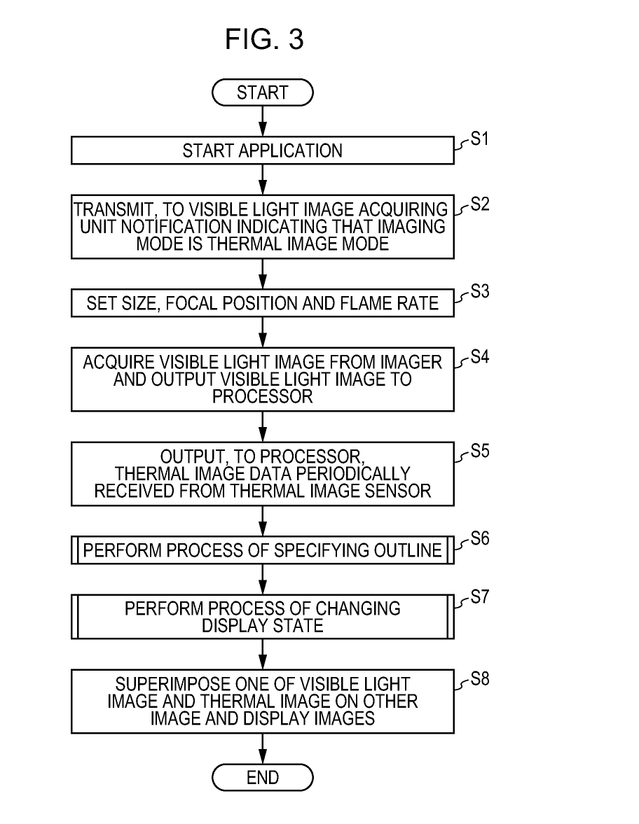

FIG. 3 is a flowchart of the operations of the information processing device 10. When a user starts a display control application of the information processing device 10 (S1), the processor 15 transmits, to the visible-light image acquiring unit 12, a notification that indicates the imaging mode is a “thermal image” mode (S2). The visible-light image acquiring unit 12 that receives the notification sets the size of an image to be acquired, a focal position, a flame rate and the like for the imager 11 (S3). For example, a mode other than the “thermal image” mode is a mode (hereinafter referred to as “visible-light image” mode) in which only a visible-light image of the object is acquired. In the visible-light image mode, the information processing device 10 calculates a focal distance between a lens and the object, causes the surface of the object to be exposed to light and causes the solid-state imaging element to receive light reflected on the surface of the object by the exposure. The information processing device 10 performs an analog-to-digital conversion to convert the received light to digital data. After that, the information processing device 10 stores the digital data as a visible-light image in the memory 10d. In the thermal image mode, the information processing device 10 acquires the visible-light image and a thermal image. In the thermal image mode, the information processing device 10 detects infrared rays emitted by the object and measures a distribution of the temperatures of parts of the surface of the object on the basis of the intensities of the infrared rays. Specifically, the information processing device 10 converts, into temperature values, the amounts of radiant energy of the infrared rays collected through the lens from the object and applies colors to the pixels on the basis of the converted temperature values on a pixel basis. After that, the information processing device 10 stores, in the memory 10d, the aforementioned visible-light image and data that serves as the thermal image and has been formed by applying the colors to the pixels.

The imager 11 images the object on the basis of the contents set in S3 and outputs, to the visible-light image acquiring unit 12, the visible-light image obtained by imaging the object. The visible-light image acquiring unit 12 acquires the visible-light image from the imager 11 and outputs the data of the visible-light image to the processor 15 (S4). The processor 15 causes the received data of the visible-light image to be stored in the memory 10d.

The thermal image acquiring unit 14 acquires the data (of the thermal image) indicating the temperature distribution and periodically received from the thermal image sensor 13 and outputs the data of the thermal image to the processor 15 (S5). The processor 15 causes the received data of the thermal image to be stored in the memory 10d.

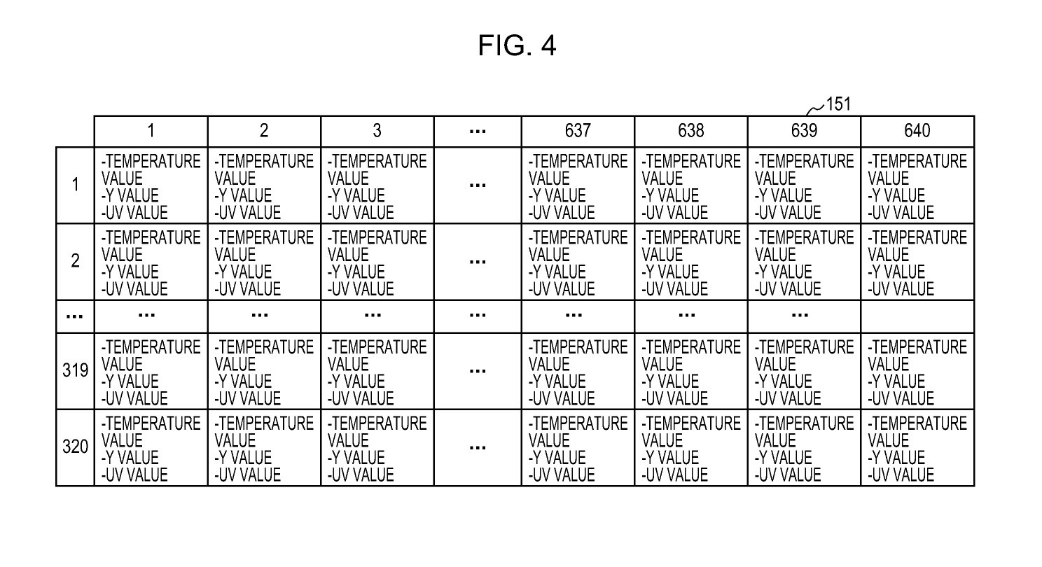

The processor 15 references the matrix information 151 matched in advance and stored in the memory 10d and performs the process of specifying the outline (S6) and the process of changing the display state (S7). An example of the matrix information 151 to be referenced is illustrated in FIG. 4. FIG. 4 is a diagram illustrating the example of the matrix information 151 in which the thermal image and the visible-light image are associated with each other. As illustrated in FIG. 4, the matrix information 151 includes temperature values, Y values and UV values for 320 rows and 640 columns so that the temperature values, the Y values and the UV values are associated with all pixels (640×320 pixels) of a display screen of the information processing device 10. The temperature values indicate the temperatures (measured by the thermal image sensor 13) of the parts of the surface of the object. The Y values indicate values of luminance signals Y of the visible-light image. The UV values each indicate values of two color-difference signals U and V of the visible-light image. The temperature values, the Y values and the UV values are held by the memory 10d so that the temperature values, the Y values and the UV values can be individually updated on the basis of a movement of the object and changes in the temperatures of the parts of the surface of the object.

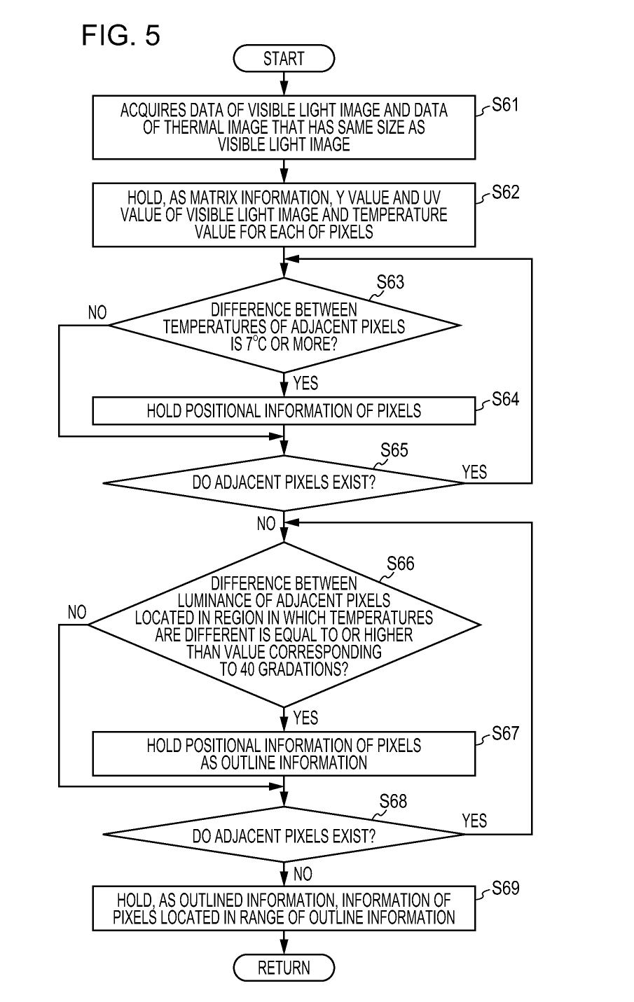

The process (to be performed in S6) of specifying an outline is described with reference to FIG. 5.

FIG. 5 is a flowchart of the process of specifying an outline on the visible-light image. In S61 illustrated in FIG. 5, the processor 15 acquires, from the memory 10d, the data (held in S4) of the visible-light image and the data (held in S5) of the thermal image that has the same size as the visible-light image. Next, the processor 15 acquires, as the matrix information 151, the Y values included in the data of the visible-light image and provided for the pixels, the UV values included in the data of the visible-light image and provided for the pixels, and the temperature values included in the data of the thermal image and provided for the pixels, and causes the matrix information 151 to be stored in the memory 10d (S62). In this case, the matrix information 151 is acquired on a pixel basis and a row basis in order from the top of the data of the thermal image and the top of the data of the visible-light image.

The processor 15 determines, on the basis of the matrix information 151, whether or not the difference between the temperature values of any adjacent pixels is equal to or higher than a predetermined value (for example, 7° C.) (S63). In this case, the determination is made on a pixel basis and a row basis in order from the top of the data of the thermal image. When the difference between the temperature values of any adjacent pixels is equal to or higher than the predetermined value (7° C.) (Yes in S63), the processor 15 causes values that are a row and column of one of the adjacent pixels and a row and column of the other of the adjacent pixels to be stored as “positional information” in the memory 10d (S64). On the other hand, when differences between the temperature values of all adjacent pixels are lower than the predetermined value (7° C.) (No in S63), the processor 15 omits S64 and causes the process to proceed to S65.

S63 and S64 are repeatedly performed on all of the pixels of the thermal image. The processor 15 determines whether or not adjacent pixels on which S63 is yet to be performed exist (S65). When adjacent pixels on which S63 is yet to be performed exist (Yes in S65), the processor 15 causes the process to return to S63. When adjacent pixels on which S63 is yet to be performed do not exist (No in S65), the processor 15 causes the process to proceed to S66.

In S66, the processor 15 determines whether or not the difference (difference between Y values of any adjacent pixels) between luminance of any adjacent pixels is equal to or larger than a value corresponding to a certain number of gradations (for example, 40 gradations) in the case where an image of each of the pixels can be displayed using 256 gradations. In S66, the processor 15 does not make the determination on all of the pixels of the visible-light image and makes the determination only on a region corresponding to positional information, which is stored at S64, of pixels whose temperatures are different. Thus, the processor 15 does not make the determination on differences between luminance of pixels within a region of which temperatures of parts are each determined not to be different by the predetermined value (7° C.) or more from the other temperatures. Thus, a load that is applied to the process of specifying an outline is reduced and the speed of the process of specifying an outline increases, compared with a determination process to be performed on all of the pixels.

When the processor 15 determines that the difference between the luminance of any adjacent pixels is equal to or larger than the value corresponding to the certain number of gradations (40 gradations) (Yes in S66) as a result of S66, the processor 15 causes the positional information (held in S64) of the adjacent pixels to be stored as “outline information” in the memory 10d (S67). On the other hand, when the processor 15 determines that differences between the luminance of all adjacent pixels are smaller than the value corresponding to the certain number of gradations (40 gradations) (No in S66), the processor 15 omits S67 and causes the process to proceed to S68.

The processor 15 may not perform the determination process on differences between the luminance of all adjacent pixels within a certain region whose temperature is determined to be different from another region surrounding the certain region. The processor 15 may determine whether or not differences between the luminance of adjacent pixels located near a boundary between the certain region whose temperature is different (from the other region surrounding the certain region) and the other region. In this case, since the processor 15 does not identify the difference between the luminance of pixels within the certain region whose temperature is different, the processor 15 does not specify an outline of a part within the certain region. However, the processor 15 can identify the difference between the luminance of pixels located near the boundary between the certain region and the other region. Thus, the processor 15 can specify a part (outline) that surrounds the certain region whose temperature is different. The processor 15 performs the determination process only on the differences between the luminance of the pixels located near the boundary. In other words, the processor 15 performs the determination process on the differences between the luminance of the pixels located in the limited region, compared with the determination process to be performed only on a region of which the difference between the temperature values of pixels is determined to be equal to or larger than the predetermined value (7° C.). Thus, the pixels to be subjected to the process of determining differences between the luminance are only pixels to be used to specify the outline. Therefore, the load that is applied to the process of specifying an outline is reduced, and the speed of the process of specifying an outline increases.

S66 and S67 are repeatedly performed on all of the pixels that are included in the data of the visible-light image and located in the certain region whose temperature is different from the other region surrounding the certain region. The processor 15 determines whether or not adjacent pixels on which S66 is yet to be performed exist (S68). When adjacent pixels on which S66 is yet to be performed exist (Yes in S68), the processor 15 causes the process to return to S66. When adjacent pixels on which S66 is yet to be performed do not exist (No in S68), the processor 15 causes the process to proceed to S69.

In S69, the processor 15 holds, as “outlined information”, information of pixels located in a range corresponding to the positional information that is among the positional information held in S64 and is held as the outline information in S67. Thus, a certain part that is included in the object and whose temperature is different from another part (of the object) surrounding the certain part can be specified on the data of the visible-light image on the basis of the outlined information.

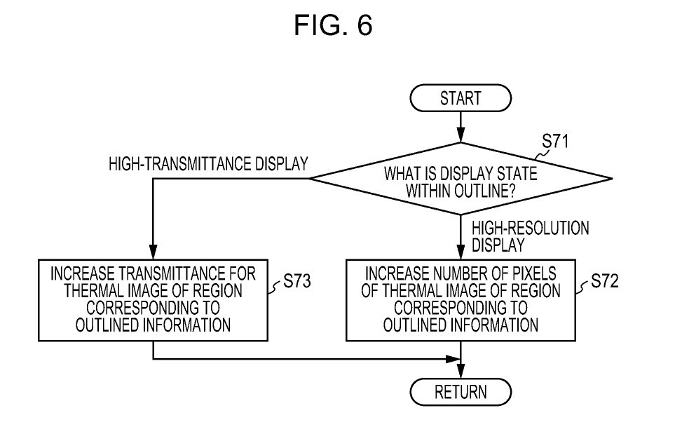

Next, the process (to be performed in S7) of changing the display state is described with reference to FIG. 6.

FIG. 6 is a flowchart of the process of changing the display state of the specific region of the thermal image. In S71, the processor 15 determines whether the display state is the high-resolution state or the high-transmittance state. The display state is set to the high-resolution state in advance. However, the display state can be changed to the high-transmittance state automatically or by a user's manual operation.

In S71, when the high-resolution state is to be set as the display state, the processor 15 increases the number of pixels of a thermal image of a region corresponding to the outlined information (S72). A method for increasing the number of the pixels of the thermal image when the information processing device 10 has the display device 10e capable of displaying up to 1200×600 pixels is described below in detail as an example. Before the display state of the thermal image located in the specified outline is changed, the thermal image has 400×200 pixels and is displayed, for example. In S72, the information processing device 10 changes the number of the pixels of the thermal image from the 400×200 pixels to 600×300 pixels or 1200×600 pixels, for example. Specifically, before the change in the display state, the processor 15 specifies a minimal pixel that is among minimal pixels forming the data of the thermal image located in the region (whose display state is to be changed) and is located at an upper-left corner of the thermal image. Then, the processor 15 treats, as a temperature value, the average of temperature values of pixels located in a region that is formed by 3 rows and 3 columns and has the pixel located at the upper-left corner. In S72 of changing the display state, the processor 15 specifies, on the basis of the outlined information held in S69, the region whose display state is to be changed, and the processor 15 specifies an element that corresponds to the minimal pixel that is among the minimal pixels forming the data of the thermal image located in the region (whose display state is to be changed) and is located at the upper-left corner of the thermal image. Next, the processor 15 updates the matrix information 151 by using the specified element located at the upper-left corner as a reference point and changing the display state of the region to the high-resolution state or changing the display state from 2 rows and 2 columns (4 pixels) to 3 rows and 3 columns (9 pixels). The number of the minimal pixels to be used to calculate the aforementioned average is increased from the 4 pixels (2 rows and 2 columns) to the 9 pixels (3 rows and 3 columns). The data of the thermal image located in the region corresponding to the outlined information is updated to data that has a temperature distribution mapped with a larger number of pixels (by 9/4 times in the example) than before the change in the display state.

In S71, when the display state is to be set to the “high-transmittance state”, the processor 15 increases a transmittance for a display color of the thermal image located in the region corresponding to the outlined information held in S69 (S73). The data of the thermal image located in the region corresponding to the outlined information is updated to data that has a temperature distribution mapped with a higher transmittance than before the change in the display state. When a transmittance for a region located outside the specified outline is 0%, and the transmittance for the region located in the specified outline before the change in the display state is 20%, the higher transmittance than before the change in the display state is about 50%, for example.

Returning to FIG. 3, in S8, the processor 15 superimposes one of the visible-light image received in S4 and the thermal image received in S5 on the other image and causes the display device 10e to display the visible-light image and the thermal image.

As described above, the information processing device 10 according to the embodiment superimposes one of the visible-light image received in S4 and the thermal image received in S5 on the other image and displays the visible-light image and the thermal image. The information processing device 10 includes the visible-light image acquiring unit 12, the thermal image acquiring unit 14 and the processor 15. The visible-light image acquiring unit 12 acquires the visible-light image of the object. The thermal image acquiring unit 14 acquires the thermal image that indicates the temperature distribution of the object. The processer 15 uses the acquired visible-light image and the acquired thermal image and specifies the part whose temperature is different from the other part surrounding the specified part. Then, the processor 15 causes the display device 10e to display the thermal image of the specified part so that the display state of the thermal image of the specified part is different from the other parts. The specified part (of the object) whose temperature is different from the other part surrounding the specified part is displayed in a display state that is different from the other parts on an entire image displayed by the information processing device 10. Thus, the user can clearly and easily identify the temperature distribution of the specified part of the object. In addition, the information processing device 10 changes only the display state of the thermal image of the specified part. Thus, the size of an image region to be processed is reduced, compared with the case in which a display state of the entire image is changed. As a result, loads that are applied to the processes related to the display control are reduced and the speeds of the processes increase.

The processor 15 can causes the display device 10e to display the thermal image of the specified part with a larger number of pixels than other parts (of the object) that each have the same size as the specified part. The information processing device 10 displays the specified part (that is included in the object and whose temperature is different from the other part surrounding the specified part) with the larger number of pixels than the other parts and displays each of the other parts with pixels whose number is equal to the number of pixels of the specified part before the change in the display state. Thus, the temperature distribution of the specified part of the object is displayed in detail. When the temperature distribution of the thermal image is displayed in detail, the user can easily identify a part of the object on the basis of the thermal image and clearly recognize corresponding relationships between parts of the surface of the object and the temperatures of the parts.

In addition, the processor 15 can cause the display device 10e to display the thermal image of the specified part with a higher transmittance than the other parts. Specifically, the information processing device 10 displays the specified part (of the object) whose temperature is different from the other part surrounding the specified part so that the transmittance for the specified part is higher than the transmittance for the other parts. The information processing device 10 displays the other parts with the transmittance that is equal to the transmittance before the change in the display state. Thus, the visible-light image of the specified part of the object passes through the thermal image (colors of the temperature distribution), is displayed without being hidden by the thermal image, and reaches the eyes of the user so that the visible-light image is easily viewed by the user. When the visible-light image is displayed, the user can easily identify a part of the object on the basis of the visible-light image. Thus, the user can clearly recognize the corresponding relationships between the parts of the surface of the object and the temperatures of the parts by referencing the displayed visible-light image and the displayed thermal image.

In the embodiment, the information processing device 10 according to the embodiment sets the display state of the region located in the specified outline to either the high-resolution state or the high-transmittance state. However, the region located in the specified outline may be displayed with a high resolution and a high transmittance. In this case, the information processing device 10 can easily and quickly match the visible-light image with the thermal image in detail by using an advantage of the high-resolution state of the detailed temperature distribution and an advantage of the high-transmittance state enabling a part of the object to be easily specified on the basis of the visible-light image. As a result, the temperature distribution (of the region located in the outline) that corresponds to the specified part of the object can be clearly and easily identified. For example, when the object is a human body or a part of the human body, the user can identify the temperatures of parts of the human body specifically (high resolution) and clearly (high transmittance). In addition, when the object is not a human body (or is frying oil and a baby bottle), or when objects that have temperatures that are nearly equal to each other exist on the same image, it is difficult to identify an object (to be measured) among the objects only on the basis of the thermal image. In this case, the information processing device 10 increases a transmittance for the thermal image and displays the thermal image and a clear visible-light image. Thus, the user can accurately and easily identify an object (to be measured) that is among a plurality of objects that exist on an image.

In the aforementioned embodiment, the display state of the region located in the outline is set to the high-resolution state in advance. However, the information processing device 10 is not limited to the embodiment. The information processing device 10 may set a criterion for selecting a display state and automatically select any of the high-resolution state and the high-transmittance state on the basis of whether or not the criterion is satisfied. As the criterion, the average of the matrix information (temperature values) of the pixels located in the outline may be used and the display state is determined on the basis of whether or not the average of the matrix information is in a temperature range of a human body. Specifically, when a temperature value of a part located in the outline is not in a range of human body's temperatures (of approximately 30° C. to 38° C.), the information processing device 10 selects the high-resolution state as the display state. On the other hand, when the temperature value of the part located in the outline is in the range of the human body's temperatures, the information processing device 10 selects the high-transmittance state as the display state.

When the temperature value of the part located in the outline is in the range of the human body's temperatures, the object that is displayed in the outline is likely to be a human body or a part of the human body. Since differences between the temperatures of parts of the human body are small, it is difficult to identify the parts on the basis of the differences between the temperatures. Thus, it is preferable to prioritize the ease of the identification of the parts over display of a detailed temperature distribution. In order to enable the parts to be identified on the basis of a visible-light image, it is preferable to easily view the visible-light image. Thus, the information processing device 10 selects the high-transmittance state as the display state. On the other hand, when the temperature value of the part located in the outline is not in the range of the human body's temperatures, the object that is displayed in the outline is unlikely to be a human body or a part of the human body. Since differences between the temperatures of parts of an object (for example, frying oil) other than a human body are large, compared with the human body, it is relatively easy to identify a part of the object on the basis of the differences between the temperatures. In addition, it is highly expected to identify the part of the object. Thus, it is preferable to prioritize display of a detailed temperature distribution of the object over the ease of the identification of the part. Specifically, it is preferable to increase the resolution of a thermal image and thereby visually, easily identify the detailed temperature distribution on the basis of the thermal image. Therefore, the information processing device 10 selects the high-resolution state as the display state.

As described above, the information processing device 10 can change the display state on the basis of the type and state of the object in accordance with the predetermined criterion and display an image in a state that is suitable for the object. Thus, the information processing device 10 can achieve accurate display control using the advantages of the different multiple display states (high-resolution state and high-transmittance state). As a result, the convenience and practicability of the information processing device 10 are improved.

In the embodiment, the information processing device 10 uses the difference between the luminance of the visible-light image in order to specify the outline (or identify the outline). The information processing device 10 is not limited to the embodiment. The information processing device 10 may use the difference between colors. Since it is difficult to identify the difference between the colors compared with the luminance, it is preferable to use a combination of the luminance and the colors that compensate for the luminance. However, the colors may be used without the luminance. The information processing device 10 may use the luminance and the colors and thereby accurately specify the outline. Thus, the user can clearly and accurately identify a part (of the object) whose temperature is different from other parts of the object.

In the embodiment, the information processing device 10 changes the display state of the part whose temperature is different from the other part surrounding the part. The information processing device 10 is not limited to the embodiment. The information processing device 10 may change a display state of a part (of the object) whose attributes (brightness, saturation, phase and the like) of a color of a thermal image are different from other parts of the object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing device that overlaps and displays a visible-light image and a thermal image, comprising:
a visible-light image acquiring unit that acquires a visible-light image of an object;
a thermal image acquiring unit that acquires a thermal image specifying a temperature distribution of the object; and
a display controller that uses the acquired visible-light image and the acquired thermal image and specifies a thermal image of a certain part whose temperature is different from another part surrounding the certain part of the object and controls to display the thermal image of the certain part to be displayed in a display state that is different from other parts of the object.

2. The information processing device according to claim 1,
wherein the display controller controls to display the thermal image of the certain part to be displayed with a higher resolution than the other parts.

3. The information processing device according to claim 1,
wherein the display controller controls to display the thermal image of the certain part to be displayed with a higher transmittance than the other parts.

4. An information processing method of overlapping and displaying a visible-light image and a thermal image, comprising:
acquiring a visible-light image of an object and a thermal image of the object;
using the acquired visible-light image and the acquired thermal image and specifying a thermal image of a certain part whose temperature is different from another part surrounding the certain part of the object; and
controlling to display the thermal image of the certain part to be displayed in a display state that is different from other parts of the object.
